(19) United States
(12) Patent Application Publication
(10) Pub. No.: US 2022/0146376 A1
(43) Pub. Date: May 12, 2022

(54) DIAGNOSIS DEVICE VERIFICATION SYSTEM AND DIAGNOSIS DEVICE VERIFICATION METHOD

(71) Applicant: Honda Motor Co., Ltd., Tokyo (JP)

(72) Inventors: Yuki Harada, Hagagun, Tochigi (JP); Naoki Kobayashi, Hagagun, Tochigi (JP); Takuya Handa, Chuo-ku, Tokyo (JP); Ken Kanai, Chuo-ku, Tokyo (JP)

(21) Appl. No.: 17/434,379

(22) PCT Filed: Feb. 26, 2020
(86) PCT No.: PCT/JP2020/007692

§ 371 Date: Aug. 26, 2021

(30) Foreign Application Priority Data
Mar. 1, 2019 (JP) 2019-037400

(51) Int. Cl. G01M 17/007

(52) U.S. Cl. CPC G01M 17/007

(57) ABSTRACT

Diagnosis device verification system includes: a diagnosis device communicably connected to a vehicle controller mounted on a vehicle, and configured to diagnose the vehicle; a simulator configured to perform simulation operation of the vehicle controller; and a verification device configured to verify operation of the diagnosis device. The diagnosis device is configured to output a diagnosis result acquired by communication with the simulator. The verification device includes: an item instruction unit configured to instruct a diagnosis item to be diagnosed to the diagnosis device; a response instruction unit configured to instruct response content corresponding to the diagnosis to the simulator; an information acquisition unit configured to acquire the diagnosis result output from the diagnosis device; and a comparison unit configured to compare the diagnosis result acquired by the information acquisition unit and the response content corresponding to the diagnosis item instructed by the response instruction unit.

### CROSS-REFERENCE TO RELATED APPLICATION

This application is a National Stage of PCT international application Ser. No. PCT/JP2020/007692 filed on Feb. 26, 2020 which designates the United States, incorporated herein by reference, and which is based upon and claims the benefit of priority from Japanese Patent Application No. 2019-037400, filed on Mar. 1, 2019, the entire contents of which are incorporated herein by reference.

### TECHNICAL FIELD

This invention relates to a diagnosis device verification system and a diagnosis device verification method configured to verify operation of a vehicle diagnosis device.

### BACKGROUND ART

Conventionally, there has been known a vehicle diagnosis device which performs diagnosis by communicating with a vehicle controller (ECU), and which records operation of the diagnosis device and automatically performs diagnosis by reproducing the recorded operation (for example, see Patent Document 1). In the device described in Patent Document 1, operation of the diagnosis device by the user, diagnostic commands transmitted from the diagnosis device to the ECU, and diagnostic results received by the diagnosis device from the ECU are recorded and stored as reproducible electronic files.

### CITATION LIST

### Patent Literature

Patent Document 1: Japanese Unexamined Patent Publication No. 2006-219092

### DISCLOSURE OF INVENTION

### Problems to be Solved by the Invention

Since the diagnosis device performs different diagnosis according to the vehicle type (vehicle model), version of the software program of the diagnosis device is upgraded in accordance with the vehicle model and it becomes necessary to verify whether the diagnosis device operates normally for every upgrading. However, if a verification worker manually verifies operation of the diagnosis device, a large number of verification items requires much labor.

### Means for Solving Problem

An aspect of the present invention is a diagnosis device verification system, including: a diagnosis device communicably connected to a vehicle controller mounted on a vehicle, and configured to diagnose the vehicle; a simulator configured to perform simulation operation of the vehicle controller; and a verification device communicably connected to the diagnosis device and the simulator, and configured to verify operation of the diagnosis device. The diagnosis device is configured to output a diagnosis result acquired by communication with the simulator. The verification device includes: an item instruction unit configured to instruct a diagnosis item to be diagnosed to the diagnosis device; a response instruction unit configured to instruct a response content corresponding to the diagnosis item instructed by the item instruction unit, to the simulator; a result acquisition unit configured to acquire the diagnosis result output from the diagnosis device; and a comparison unit configured to compare the diagnosis result acquired by the result acquisition unit and the response content corresponding to the diagnosis item instructed by the response instruction unit.

Another aspect of the present invention is a diagnosis device verification method configured to communicate with each of: a diagnosis device communicably connected to a vehicle controller mounted on a vehicle, and configured to diagnose the vehicle; and a simulator configured to perform simulation operation of the vehicle controller, and to verify operation of the diagnosis device. The diagnosis device verification method includes: instructing a diagnosis item to be diagnosed to the diagnosis device; instructing a response content corresponding to the diagnosis item instructed to the diagnosis device, to the simulator; acquiring a diagnosis result acquired by the diagnosis device by communication with the simulator; and comparing the diagnosis result acquired from the diagnosis device and the response content corresponding to the diagnosis item instructed to the diagnosis device.

### Effect of the Invention

According to the present invention, it becomes possible to automatically verify operation of the vehicle diagnosis device, thereby reducing labor of the verification worker required for verification of the software program of the diagnosis device.

### BRIEF DESCRIPTION OF DRAWINGS

FIG. 1 is a drawing schematically showing an example of diagnosis of a vehicle performed by a diagnosis device.

FIG. 2 is a drawing schematically showing an example of operation verification of diagnosis program to which a diagnosis device verification system according to an embodiment of the present invention is applied.

FIG. 3A is a drawing showing an example of a display screen of a display unit of the diagnosis device in FIG. 2, for explaining diagnosis items.

FIG. 3B is a drawing showing an example of the display screen of the display unit of the diagnosis device in FIG. 2, following FIG. 3A.

FIG. 3C is a drawing showing an example of the display screen of the display unit of the diagnosis device in FIG. 2, following FIG. 3B.

FIG. 3D is a drawing showing an example of the display screen of the display unit of the diagnosis device in FIG. 2, following FIG. 3C.

FIG. 4A is a drawing showing an example of diagnosis result displayed on the display unit of the diagnosis device in FIG. 2.

FIG. 4B is a drawing showing another example of diagnosis result displayed on the display unit of the diagnosis device in FIG. 2.

FIG. 4C is a drawing showing another example of diagnosis result displayed on the display unit of the diagnosis device in FIG. 2.

FIG. 5 is an example of a table showing existing items and new items before and after upgrading of diagnosis program.

FIG. 6 is a block diagram showing main configuration of the diagnosis device verification system according to the embodiment of the present invention.

FIG. 7A is a flowchart showing an example of verification processing performed by the diagnosis device verification system according to the embodiment of the present invention.

FIG. 7B is a flowchart showing an example of record processing performed by the diagnosis device verification system according to the embodiment of the present invention.

FIG. 8 is a block diagram showing a modification of FIG. 6.

### DESCRIPTION OF EMBODIMENT

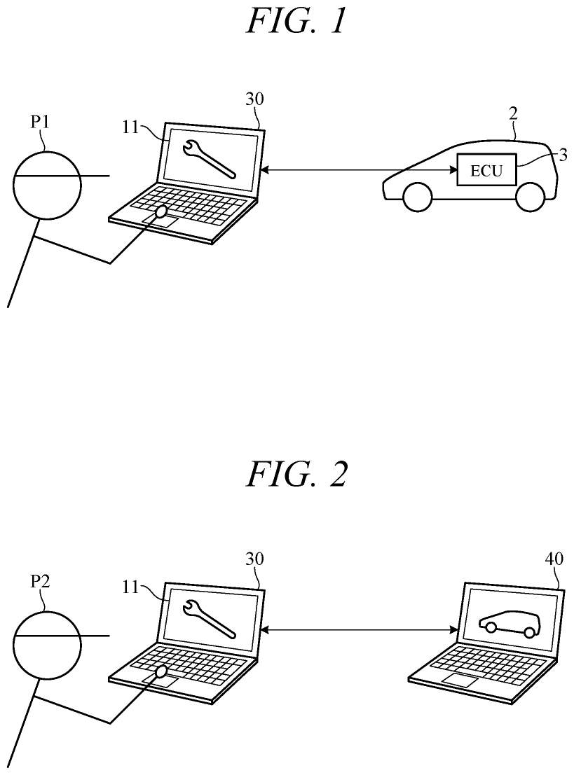

An embodiment of the present invention is explained with reference to FIG. 1 to FIG. 8 in the following. FIG. 1 is a drawing schematically showing an example of diagnosis of a vehicle 2 performed by a diagnosis device 30. As shown in FIG. 1, the diagnosis device 30 is configured as a dedicated device for diagnosis, a commercially available computer or the like, and communicably connected to an ECU 3 mounted on the vehicle 2 to be diagnosed through CAN (Controller Area Network) communication or the like. A user P1 (service staff or the like), who conducts diagnosis of the vehicle 2, conducts the diagnosis of diagnosis items required according to symptoms of the vehicle 2 using the diagnosis device 30. The diagnosis item for the diagnosis includes various items such as checking of error codes, checking of various sensor values, and the like.

Since the vehicle control software program (hereinafter, vehicle control program) of the ECU 3 for controlling operation of the vehicle 2 differs between models of the vehicle 2, the diagnosis items to be diagnosed also differ between the models. For example, in the current model with new functions added to the existing model and new error codes or new sensors added, new diagnosis items are added for checking the newly added error codes or sensor values. Version of the diagnosis software program (hereinafter, diagnosis program) of the diagnosis device 30 is upgraded as necessary in order to cope with such additional diagnosis items.

The current version of the diagnosis program is distributed to the user P1 of the diagnosis device 30 after verified with respect to normal operation on the diagnosis device 30. Such operation verification of the diagnosis program on the diagnosis device 30 can be performed using the ECU 3 mounted on the actual vehicle 2, and can also be performed using a simulator for simulating operation of the ECU 3 mounted on the vehicle 2.

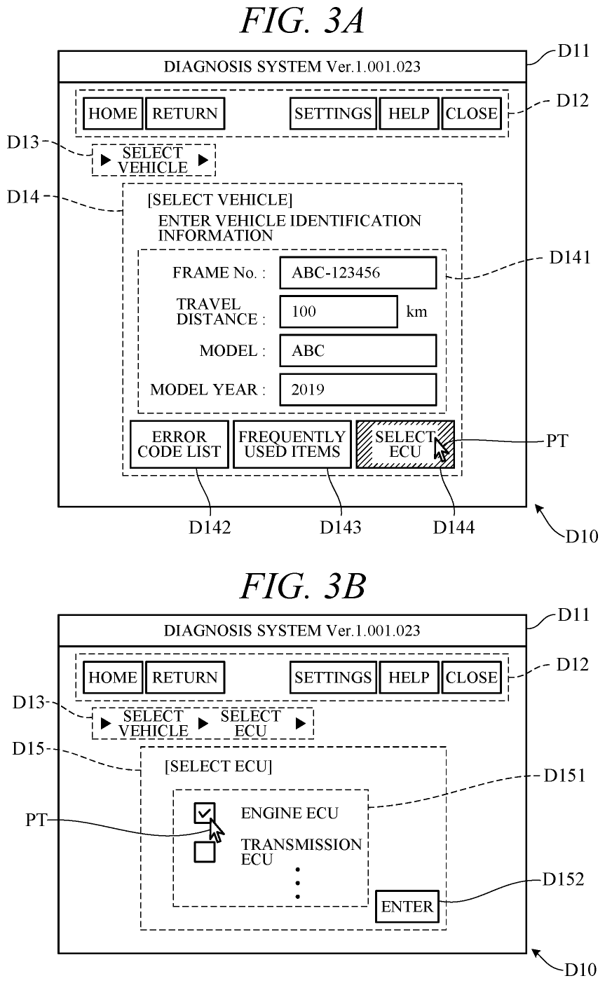

FIG. 2 is a drawing showing an example of the operation verification of the diagnosis program to which a diagnosis device verification system according to the embodiment of the present invention is applied, schematically showing the operation verification using the simulator 40. The simulator 40 is configured as a commercially available computer or the like, previously installed with the vehicle control program for the vehicle model to be diagnosed by the diagnosis program and previously set with response contents corresponding to the diagnosis items before the operation verification.

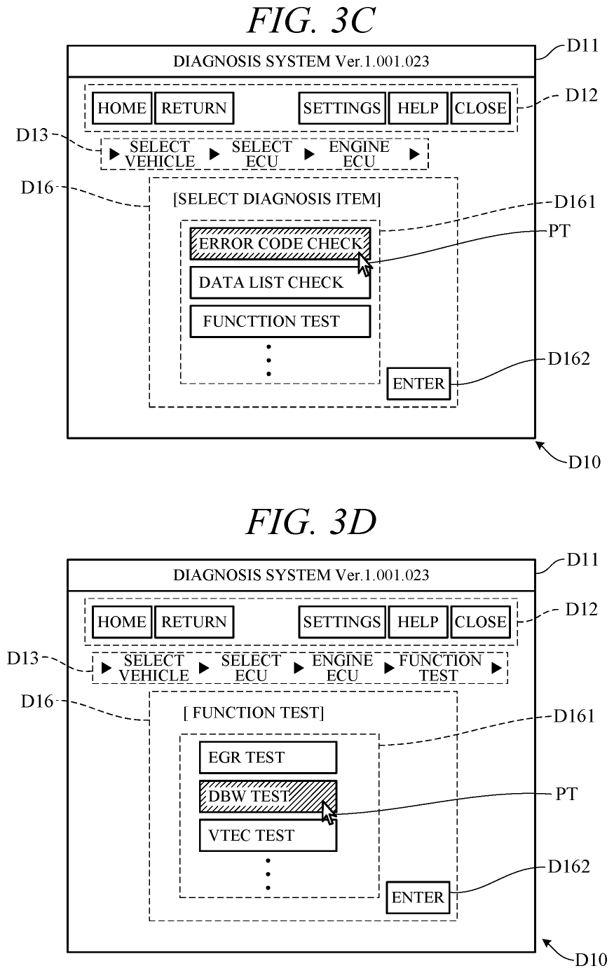

FIG. 3A to FIG. 3D are diagrams for explaining the diagnosis items, showing examples of display screens D10 of a display unit such as a display of the diagnosis device 30 installed with the diagnosis program to be verified. As shown in FIG. 3A to FIG. 3D, the display unit of the diagnosis device 30 displays the version of the installed diagnosis program (D11), various function buttons such as settings (D12), and a hierarchy of the current display screen (D13).

FIG. 3A is an example of a vehicle selection screen D14 for selecting model or the like of the vehicle 2 to be diagnosed. The verification worker P2 conducting operation verification of the diagnosis program (FIG. 2) enters identification information such as the model of the vehicle 2 in an identification information input unit D141 on the vehicle selection screen D14 through an input unit such as a touch panel of the diagnosis device 30. The operation by the verification worker P2 on the display screen D10 is displayed as a pointer PT by superimposing on the display screen D10.

When the identification information of the vehicle 2 is entered in the identification information input unit D141, a menu button D142 to display a list of error codes corresponding to the model of the vehicle 2, a menu button D143 to display frequently used items, and a menu button D144 to display a list of plural ECUs 3 mounted on the vehicle 2 for selection are displayed. When the verification worker P2 touches the menu button D144 to select the ECU 3, the display screen D10 is changed to an ECU selection screen D15 in FIG. 3B.

FIG. 3B is an example of the ECU selection screen D15 for selecting the ECU 3 to be diagnosed. The vehicle 2 is mounted with multiple ECUs 3 of different functions, such as an engine ECU for controlling operation of the engine, a transmission ECU for controlling operation of the transmission, and the like corresponding to each vehicle model. When the verification worker P2 selects the ECU 3 to be diagnosed using an ECU selector D151 of the ECU selection screen D15 corresponding to the diagnosis item and touches a determination button D152 to enter it, the display screen D10 is changed to a diagnosis item selection screen D16 in FIG. 3C.

FIG. 3C and FIG. 3D are examples of the diagnosis item selection screen D16 for selecting the diagnosis item. The diagnosis includes diagnosis items such as an error code check for checking error cords representing the content of errors occurred in the vehicle 2, a data list check for checking sensor values of various sensors mounted on the vehicle 2, and a function test for checking operation of various devices mounted on the vehicle 2. As shown in FIG. 3C, when the verification worker P2 selects the diagnosis item such as the error code check or the data list check using a diagnosis item selector D161 in the diagnosis item selection screen D16 and touches a determination button D162 to enter it, a diagnosis signal indicating the diagnosis item is transmitted from the diagnosis device 30 to the simulator 40.

On the other hand, when the verification worker P2 selects the diagnosis item such as the function test using the diagnosis item selector D161 in the diagnosis item selection screen D16 and touches the determination button D162 to enter it, the display screen D10 is changed to the diagnosis item selection screen D16 in FIG. 3D. As shown in FIG. 3D, when the verification worker P2 selects the diagnosis item of a specific function test from among function tests for checking operation of various devices and touches the determination button D162 to enter it, a diagnosis signal indicating the diagnosis item is transmitted from the diagnosis device 30 to the simulator 40.

The simulator 40, upon receiving the diagnosis signal from the diagnosis device 30, transmits a response signal indicating the response content corresponding to the diagnosis item to the diagnosis device 30. The diagnosis device 30, upon receiving the response signal from the simulator 40, displays the diagnosis result on the display unit.

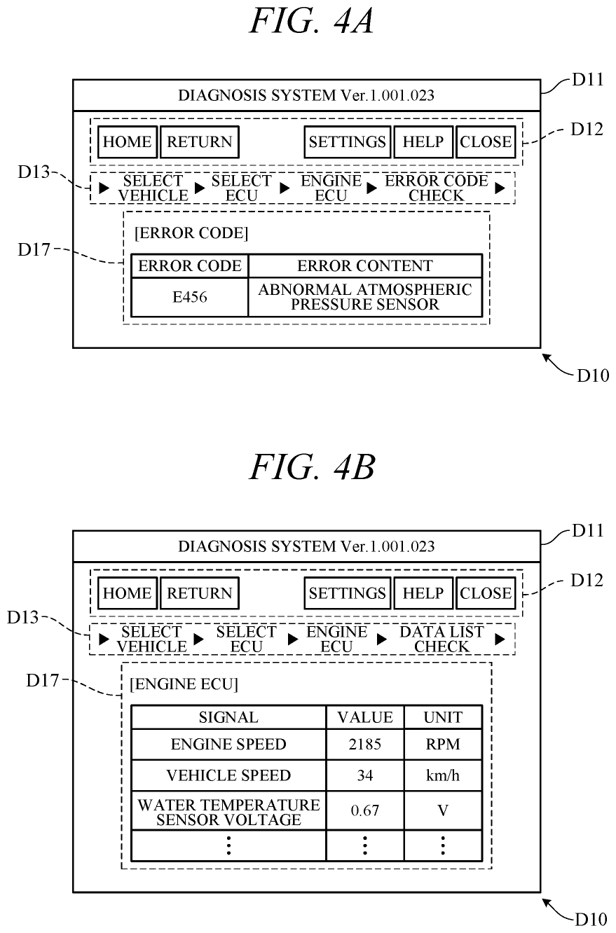

FIG. 4A to FIG. 4C are drawings showing examples of the diagnosis results displayed on the display unit of the diagnosis device 30, respectively showing a diagnosis result screen D17 representing the diagnosis results when selecting the diagnosis item of the error code check, the data list check, and the function test of the DBW (Drive-By-Wire) throttle in the diagnosis item selection screen D16 in FIG. 3C and FIG. 3D.

The verification worker P2 compares the diagnosis result screen D17 displayed on the display unit of the diagnosis device 30 with the diagnosis result screen for each diagnosis item described on the specifications or the like of the diagnosis program, and checks whether the entire screen is displayed correctly. The verification worker P2 also checks whether the diagnosis result matches the response content corresponding to the diagnosis item preset before the operation verification. Thus, it is determined whether the diagnosis program normally operates on the diagnosis device 30 for each diagnosis items.

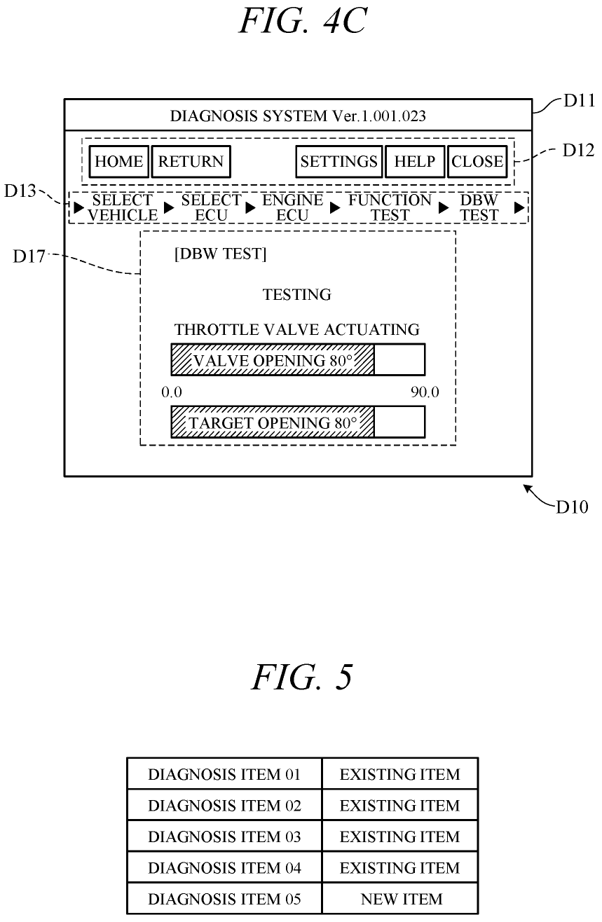

FIG. 5 is a diagram for explaining the diagnosis items of the diagnosis performed by the current version of the diagnosis program, showing an example of a table showing existing items set before upgrading of diagnosis program and new items newly set after the upgrading. In a model change of the vehicle 2, new functions, for example, a function for recognize driving lanes or preceding vehicles, are added and a new device such as camera or radar mounted on the vehicle 2 or a new type of ECU 3 for controlling the vehicle is added. Then, the diagnosis program is added with the new items for diagnosing newly added devices or ECUs 3, and the version is upgraded.

When performing diagnosis using the diagnosis device 30 installed with such a current version of the diagnosis program, the newly added new items possibly cause some effect and an unexpected error may occur in the diagnosis of the existing items. For this reason, when verifying whether the current version of the diagnosis program normally operates on the diagnosis device 30, it is preferable to perform operation verification not only for the new items, but for all the diagnosis items including the existing items.

However, as shown in FIG. 5, with such a lot of items including the existing items, labor of the verification worker P2 becomes larger if performing operation verification of all the diagnosis items for all versions of the diagnosis program. In addition to that, since the number of the diagnosis items will increase with the control content of the vehicle control program becomes complicated, in the future, by mounting advanced features such as automatic drive control, the number of the diagnosis items may also significantly increase. Therefore, in the present embodiment, the diagnosis device verification system is configured as follows so as to automatically verify whether the diagnosis program normally operates on the diagnosis device 30, and to reduce labor of the verification worker P2 required for the verification of the diagnosis program.

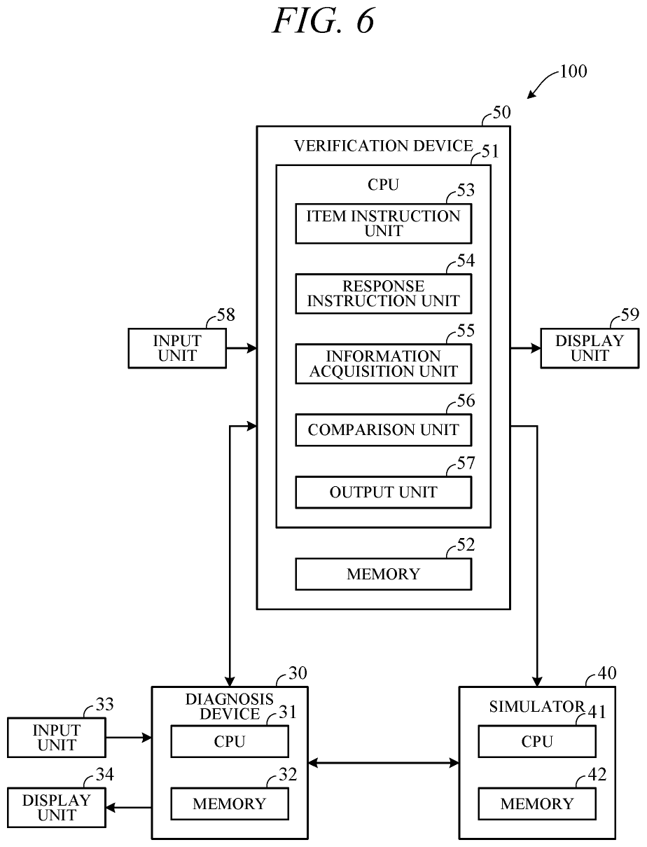

FIG. 6 is a block diagram showing main configuration of the diagnosis device verification system 100 according to the embodiment of the present invention. As shown in FIG. 6, the diagnosis device verification system 100 includes: a diagnosis device 30 installed with the diagnosis program to be verified, a simulator 40 installed with the vehicle control program and configured to perform simulation operation of the ECU 3 mounted on the vehicle 2, and a verification device 50 configured to perform the operation verification of the diagnosis program on the diagnosis device 30. The diagnosis device 30, the simulator 40, and the verification device 50 are communicably connected to each other.

The diagnosis device 30 is configured by including an arithmetic processing device having a CPU 31, a memory 32 such as a ROM, RAM, other peripheral circuits such as an I/O interface, and the like. The diagnosis device 30 is connected with an input unit 33 configured by a keyboard, a mouse, a touch panel, or the like, and a display unit 34 configured by a liquid crystal display or the like respectively by wire or wirelessly.

The CPU 31 of the diagnosis device 30 executes the diagnosis program stored in the memory 32 in accordance with instructions received from the verification device 50 to generate diagnosis signals, and transmit the generated diagnosis signals to the simulator 40. The CPU 31 of the diagnosis device 30 further processes response signals received from the simulator 40 to generate image signals for the diagnosis result screen D17 (FIG. 4A to FIG. 4C), and output the generated image signals to the display unit 34. The image signals generated by the CPU 31 of the diagnosis device 30 are acquired by the verification device 50 connected to the diagnosis device 30 as the image information in the diagnosis result screen D17, and acquired by the verification device 50 as the text information (text data) included in the diagnosis result screen D17.

The CPU 31 of the diagnosis device 30 further executes the diagnosis program stored in the memory 32 in accordance with instructions input through manual operation of the input unit 33 by the verification worker P2, as shown in FIG. 3A to FIG. 3D, to generate the diagnosis signals for each diagnosis items, and transmit the generated diagnosis signals to the simulator 40. The information of the series of operation input through the input unit 33 for each diagnosis item is acquired by the verification device 50 connected to the diagnosis device 30 and stored. Specifically, information of the motion of the pointer PT on the display screen D10 in FIG. 3A to FIG. 3D, the entering operation in the vehicle selection screen D14, the selecting operation in the ECU selection screen D15 or the diagnosis item selection screen D16, the touching operation of the menu button D144 or the determination buttons D152, D162, and the like is acquired and stored. The information of the series of operation may be stored on the diagnosis device 30 side and transmitted to the verification device 50.

The simulator 40 is configured by including an arithmetic processing device having a CPU 41, a memory 42 such as a ROM, RAM, other peripheral circuits such as an I/O interface, and the like. The memory 42 of the simulator 40 prestores the response contents corresponding to the diagnosis items received from the verification device 50 before the operation verification. The CPU 41 of the simulator 40 executes the vehicle control program stored in the memory 42 and, upon receiving the diagnosis signal from the diagnosis device 30, generates the response signal corresponding to the received diagnosis signal in accordance with the response contents corresponding to the diagnosis items stored in the memory 42 and transmits the generated response signal to the diagnosis device 30.

The verification device 50 is configured by including an arithmetic processing device having a CPU 51, a memory 52 such as a ROM, RAM, other peripheral circuits such as an I/O interface, and the like. The verification device 50 is connected with an input unit 58 configured by a keyboard, a mouse, a touch panel, or the like, and a display unit 59 configured by a liquid crystal display or the like respectively by wire or wirelessly.

The memory 52 of the verification device 50 stores the information of the series of operation and the information of the diagnosis result screen D17 (image information and text information) for each diagnosis item acquired from the diagnosis device 30 in the operation verification manually conducted by the verification worker P2. Specifically, the operation verification of the diagnosis program for the new items added in the upgrading of the diagnosis program (FIG. 5) is manually conducted by the verification worker P2. At this time, the information of the series of operation of the diagnosis device 30 by the verification worker P2 and the information of the diagnosis result screen D17 displayed on the display unit 34 of the diagnosis device 30 and checked by the verification worker P2 as to whether it is displayed normally, are acquired from the diagnosis device 30 by the verification device 50. These information are acquired by the verification device 50, stored and accumulated in the memory 52 for each diagnosis item, each time the operation verification is manually conducted by the verification worker P2 for the new item.

The memory 52 of the verification device 50 further stores the diagnosis items and the response contents corresponding to the diagnosis items input through the input unit 58. Specifically, for the new items, the response contents corresponding to the diagnosis items are input through the input unit 58 by the verification worker P2. Specifically, in accordance with the diagnosis program and the specifications of the vehicle control program, the information of the diagnosis signal output from the diagnosis device 30, and the information of the response signal simulating the response signal output from the ECU 3 corresponding to the diagnosis signal, are input. The information of the response contents corresponding to the diagnosis items is also stored and accumulated in the memory 52 for each diagnosis item, each time the operation verification is manually conducted by the verification worker P2 for the new item.

The CPU 51 functions as: an item instruction unit 53 configured to instruct the diagnosis item to the diagnosis device 30; a response instruction unit 54 configured to instruct the response content corresponding to the diagnosis item to the simulator 40; an information acquisition unit 55 configured to acquire the information of the series of operation and the diagnosis result output from the diagnosis device 30; a comparison unit 56 configured to compare the diagnosis result acquired by the information acquisition unit 55 and response content instructed by the response instruction unit 54; and an output unit 57 configured to output the comparison result by the comparison unit 56.

The item instruction unit 53 instructs (transmits) all the diagnosis items verified and stored (accumulated) in the memory 52 in the previous operation verifications of the diagnosis program up to the last time (all existing items in FIG. 5) to the diagnosis device 30, and transmits instruction of the series of operation for each diagnosis item to the diagnosis device 30 based on the information of the series of operation for each diagnosis item stored in the memory 52.

The response instruction unit 54 instructs (transmits) the response contents corresponding to all the diagnosis items stored (accumulated) in the memory 52 (existing items and the new items in FIG. 5) to the simulator 40. Specifically, the response instruction unit 54 transmits response instruction set corresponding to all the diagnosis items to the simulator 40.

The information acquisition unit 55 acquires the image information and the text information of the diagnosis result screen D17 output from the diagnosis device 30 for each diagnosis item, always acquires the information of the operation input through the input unit 33 to the diagnosis device 30, and records the acquired information as the information of the series of operation for each diagnosis item. The information of the diagnosis result screen D17 includes the information of the diagnosis result screen D17 for the existing items (FIG. 5) in the operation verification manually conducted by the verification worker P2, and the information of diagnosis result screen D17 for all the diagnosis items including the existing items and the new items (FIG. 5) in the operation verification automatically performed by the verification device 50.

The comparison unit 56 compares the information of the diagnosis result screen D17 acquired by the information acquisition unit 55 in the automatic verification by the verification device 50, and the information of the diagnosis result screen D17 acquired by the information acquisition unit 55 and stored in the memory 52 of the verification device 50 in the manual verification by the verification worker P2. Specifically, the comparison unit 56 performs comparison with the information of the diagnosis result screen D17 that has been confirmed by the verification worker P2 to normally display the diagnosis results matching with the response contents corresponding to the preset diagnosis items. Further, the comparison unit 56 determines whether the diagnosis program normally operates on the diagnosis device 30 for each diagnosis item based on the comparison result.

The image information of the diagnosis result screen D17 is compared as the image data in pixel units. In this case, the displayed positions of the various function buttons D12 (FIG. 3A to FIG. 4C) or the like may change slightly due to differences in the operation systems of the diagnostic device 30 or the like, for example. In order to cope with such a change in the display positions, correction of the display position may be performed in units of display elements such as buttons. That is, for example, if the difference between the display positions of the display elements determined to be the same by the pattern matching is within a predetermined value, it may be determined that the display is normal.

The output unit 57 outputs the comparison result and the determination result by the comparison unit 56 to the display unit 59. Specifically, the output unit 57 outputs the determination result for each diagnosis item as to whether the diagnosis program normally operates on the diagnosis device 30 to the display unit 59.

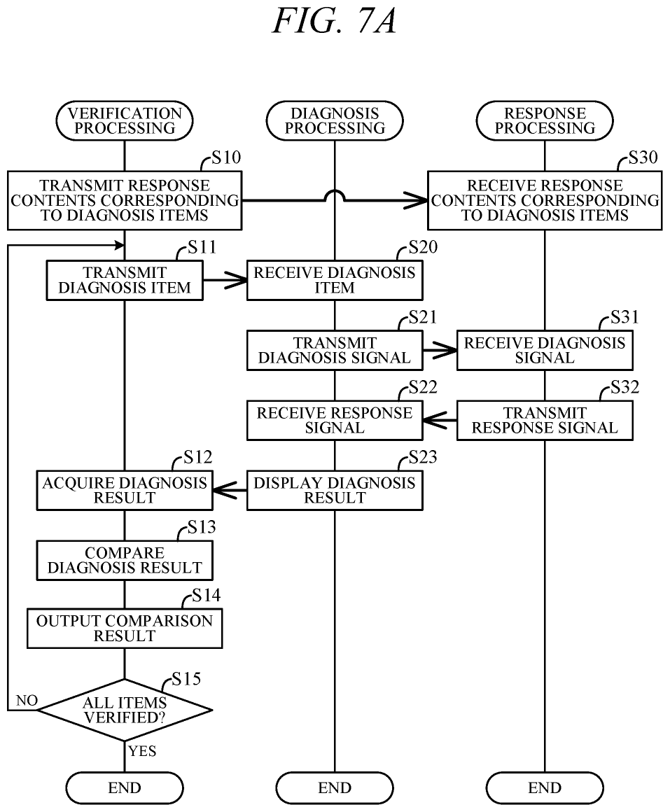

FIG. 7A and FIG. 7B are flowcharts showing examples of processing performed by the diagnosis device verification system 100, showing verification processing (FIG. 7A) and record processing (FIG. 7B) performed by the CPU 51 of the verification device 50 in accordance with the program prestored in the memory, diagnosis processing performed by the CPU 31 of the diagnosis device 30, and response processing performed by the CPU 41 of the simulator 40. The verification processing shown in the flowchart in FIG. 7A is a processing automatically performed by the diagnosis device verification system 100 for the existing items (FIG. 5), and performed when starting instruction for the operation verification of the diagnosis program is input through the input unit 58 of the verification device 50.

In the verification processing of the verification device 50, first, in step S10, by the process in the response instruction unit 54, the response contents corresponding to the diagnosis items stored in the memory 52 are transmitted to the simulator 40. In the response processing of the simulator 40, in step S30, the response contents corresponding to the diagnosis items transmitted from the verification device 50 are received. In the verification processing of the verification device 50, next, in step S11, by the process in the item instruction unit 53, the diagnosis item and the instruction of the series of operation for the respective diagnosis item stored in the memory 52 are transmitted to the diagnosis device 30 for the respective diagnosis item.

In the diagnosis processing of the diagnosis device 30, in step S20, upon receiving the diagnosis item transmitted from the verification device 50, in step S21, diagnosis signal is generated and transmitted to the simulator 40. In the response processing of the simulator 40, in step S31, upon receiving the diagnosis signal transmitted from the diagnosis device 30, in step S32, in accordance with the response content corresponding to the diagnosis item stored in the memory 42, the response signal corresponding to the diagnosis signal received in step S31 is generated and transmitted to the diagnosis device 30.

In the diagnosis processing of the diagnosis device 30, in step S22, upon receiving the response signal transmitted from the simulator 40, in step S23, the response signal received in step S22 is processed and the diagnosis result (information of the diagnosis result screen D17) is generated and output to the display unit 34.

In the verification processing of the verification device 50, in step S12, by the process in the information acquisition unit 55, the diagnosis result is acquired from the diagnosis device 30. Next, in step S13, by the process in the comparison unit 56, the diagnosis result acquired in step S12 is compared with the diagnosis result stored in the memory 52 and, based on the comparison result, it is determined whether the diagnosis program normally operates on the diagnosis device 30 for the diagnosis item. Next, in step S14, by the process in the output unit 57, the comparison result and the determination result acquired in step S13 are output to the display unit 59.

Next, in step S15, by the process in the item instruction unit 53, it is determined whether the processing in step S11 to S14 has been performed for all the diagnosis items stored in the memory 52. When step S15 is negative, the processing returns to step S11. When step S15 is affirmative, the processing ends.

The record processing shown in the flowchart in FIG. 7B is a processing performed by the diagnosis device verification system 100 to automatically record the manual operation by the verification worker P2 to the diagnosis device 30 for the new items (FIG. 5) and the verification result thereof (FIG. 4A to FIG. 4C), and performed when starting instruction for the diagnosis is input through the input unit 33 of the diagnosis device 30.

To explain focusing on the points differing from the verification processing shown in the flowchart in FIG. 7A, in the diagnosis processing of the diagnosis device 30, in step S24, a series of manual operation is input through the input unit 33 by the verification worker P2. Next, in step S21, in accordance with the instruction by the manual operation of the verification worker P2, the diagnosis signal is generated and transmitted to the simulator 40. Then, in step S22, upon receiving the response signal from the simulator 40, in step S23, the response signal received in step S22 is processed and the diagnosis result (information of the diagnosis result screen D17) is generated and output to the display unit 34.

In the record processing of the verification device 50, in step S16, by the process in the information acquisition unit 55, the information of the series of operation is acquired from the diagnosis device 30, in step S17, the diagnosis result is acquired from the diagnosis device 30 and stored in the memory 52 for the respective diagnosis item.

The main operation of the diagnosis device verification system 100 according to the present embodiment will be described in more detail. When the version of the diagnosis program is upgraded in accordance with the current model of the vehicle 2, the operation verification as to whether the current version of the diagnosis program normally operates on the diagnosis device 30 is manually conducted by the verification worker P2 for the newly added diagnosis items. The manual operation of the diagnosis device 30 by the verification worker P2 is recorded for each diagnosis item (step S24, S16 in FIG. 7B). The verification result for each diagnosis item for which the operation verification is conducted by the verification worker P2 is also recorded (step S23, S17).

The operation verification of the current version of the diagnosis program is automatically performed for the existing items previously set before the upgrading. The verification worker P2 operates the input unit 58 of the verification device 50 to start the operation verification of the existing items (step S10 to S15 in FIG. 7A). The verification worker P2 checks the verification result displayed on the display unit 59 of the verification device 50 as to whether an unexpected error has not occurred for the existing items (step S14).

In the operation verification of the current version of the diagnosis program, since the operation verification for a large number of existing items is automatically performed, it becomes possible to reduce labor of the verification worker P2. Further, every time when the version of the diagnosis program is upgraded, the information of the series of operation of the diagnosis device 30 manually conducted by the verification worker P2 and the information of the diagnosis result screen D17 checked by the verification worker P2 as to whether it is displayed normally are recorded and accumulated for the new items. Therefore, in the operation verification of the current version of the diagnosis program, the diagnosis items requiring the manual verification operation by the verification worker P2 are narrowed down, thereby enabling to reduce labor of the verification worker P2.

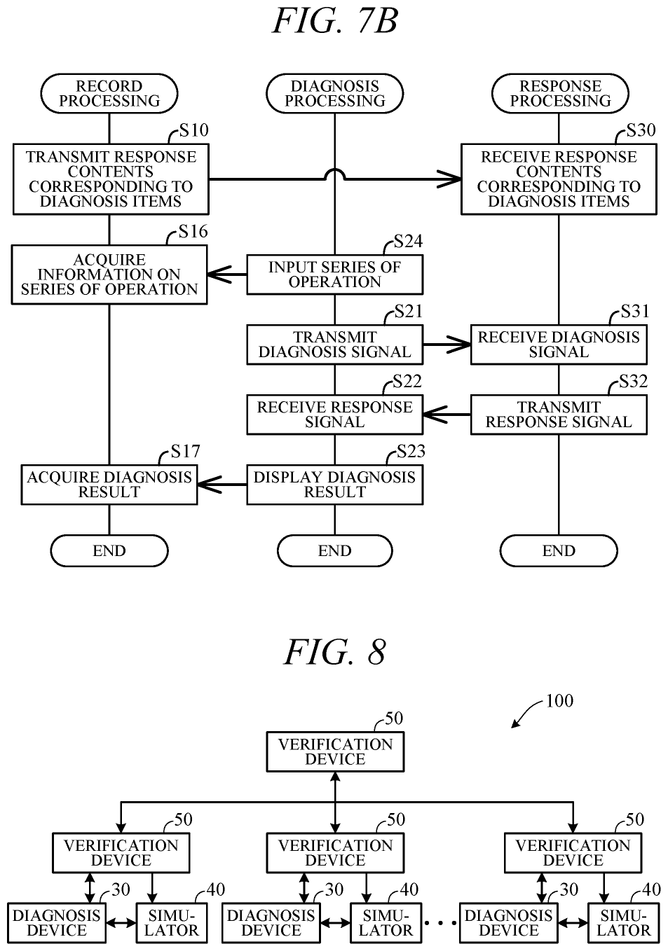

FIG. 8 is a block diagram showing a modification of FIG. 6, showing main configuration of the modification of the diagnosis device verification system 100 according to the embodiment of the present invention. Although the verification device 50 has been described as one computer in FIG. 6, the verification device 50 may be configured by plural computers. For example, as shown in FIG. 8, it can also be possible to configure each of one master computer and plural slave computers as the verification device 50 shown in FIG. 6.

When the diagnosis device verification system 100 is configured as shown in FIG. 8, the master computer instructs verification of different verification items to the respective plural slave computers, and receives the verification results output from the plural slave computers. By dispersing the diagnosis items for the operation verification of the diagnosis program between the plural slave computers, it becomes possible to reduce the time required for the verification. In this case, regarding the slave computer, the response instruction unit 54 and the comparison unit 56 may be omitted from the configuration of the CPU 51 of the verification device 50 in FIG. 6.

According to the embodiment of the present invention, the following advantageous effects can be obtained:

(1) The diagnosis device verification system 100 includes: the diagnosis device 30 communicably connected to the ECU 3 mounted on the vehicle 2, and configured to diagnose the vehicle 2; the simulator 40 configured to perform simulation operation of the ECU 3; and the verification device 50 communicably connected to the diagnosis device 30 and the simulator 40, and configured to verify operation of the diagnosis device 30 (FIG. 6). The diagnosis device 30 is configured to output the diagnosis result acquired by the communication with the simulator 40.

The verification device 50 includes: the item instruction unit 53 configured to instruct the diagnosis item to be diagnosed to the diagnosis device 30; the response instruction unit 54 configured to instruct the response content corresponding to the diagnosis item instructed by the item instruction unit 53, to the simulator 40; the information acquisition unit 55 configured to acquire the diagnosis result output from the diagnosis device 30; and the comparison unit 56 configured to compare the diagnosis result acquired by the information acquisition unit 55 and the response content corresponding to the diagnosis item instructed by the response instruction unit 54 (FIG. 6). With this, it becomes possible to automatically verify whether the diagnosis program normally operates on the diagnosis device 30, thereby reducing labor of the verification worker P2 required for verification of the diagnosis program.

(2) The diagnosis device 30 includes: the display unit 34 configured to display the diagnosis result acquired by the communication with the simulator 40 (FIG. 6). The comparison unit 56 compares: at least one of the text information and the image information included in the diagnosis result displayed on the display unit 34; and at least one of the text information and the image information included in the response content corresponding to the diagnosis item instructed by the response instruction unit 54. Since it is possible to acquire the diagnosis result including the text information and the image information from the diagnosis device 30, and to compare the image data in pixel units or the text data, it becomes possible to automatically and accurately perform operation verification of the diagnosis program.

(3) The diagnosis device verification system 100 further includes: plural slave computers respectively including the verification device 50; and a master computer configured to integrate the slave computers (FIG. 8). The slave computers respectively output the verification result by performing verification of the verification item different from each other. The master computer receives the verification result output from the slave computers. With this, it becomes possible to reduce the time required for the verification of the diagnosis program for plural diagnosis items.

(4) The verification device 50 further includes: the memory 52 configured to store: the existing item previously set corresponding to the first model to be diagnosed by the diagnosis device 30; and all the diagnosis items set corresponding to the second model to be diagnosed by the diagnosis device 30 and including the existing item and the new item added to the existing item; and the input unit 33 configured to input the new item (FIG. 6).

The item instruction unit 53 instructs the existing item stored in the memory 52 to the diagnosis device 30 when the first model is to be diagnosed by the diagnosis device 30, while instructs all the diagnosis items stored in the memory 52 to the diagnosis device 30 when the second model is to be diagnosed by the diagnosis device 30. Specifically, since for every upgraded version of the diagnosis program the new item before the upgrading is accumulated as the existing item after the upgrading, it becomes possible to reduce labor of the verification worker P2 required for verification of the current version of the diagnosis program.

The above embodiment may be modified into various forms. In the following, modified examples will be described. Although the simulator 40 configured as a commercially available computer or the like is exemplified in the above embodiment, a simulator configured to perform simulation operation of a vehicle controller is not limited to the one described above. For example, the actual ECU 3 with setting values (the response contents for the diagnosis items) set for the operation verification may be used as the simulator 40.

Although the information acquisition unit 55 of the verification device 50 acquires the image signal output from the diagnosis device 30 in the above embodiment, a result acquisition unit configured to acquire the diagnosis result output from the diagnosis device is not limited to the one described above. For example, it is also possible to provide a camera for photographing the display unit 34 of the diagnosis device 30 to acquire the image information photographed by the camera.

Although the information of the series of operation by the verification worker P2 and the diagnosis items input through the input unit 58 are stored in the memory 52 of the verification device 50 in the above embodiment, a storage unit configured to store first and second diagnosis items previously set corresponding to first and second models to be diagnosed by the diagnosis device is not limited to the one described above. The storage unit may be provided separately from the verification device 50, for example, the storage unit may be an external memory connected to the verification device 50, a storage area on a server, or the like.

In the above, although the present invention is described as the diagnosis device verification system 100, the present invention may be used as a diagnosis device verification method configured to communicate with each of: a diagnosis device communicably connected to a vehicle controller mounted on a vehicle, and configured to diagnose the vehicle; and a simulator configured to perform simulation operation of the vehicle controller, and to verify operation of the diagnosis device. Specifically, the diagnosis device verification method includes: instructing the diagnosis item to be diagnosed to the diagnosis device 30 (step S11 in FIG. 7A); instructing the response content corresponding to the diagnosis item instructed to the diagnosis device 30, to the simulator 40 (step S10); acquiring the diagnosis result acquired by the diagnosis device 30 by communication with the simulator 40 (step S12); and comparing the diagnosis result acquired from the diagnosis device 30 and the response content corresponding to the diagnosis item instructed to the simulator 40 (step S13).

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

2 vehicle, 3 ECU, 30 diagnosis device, 31 CPU, 32 memory, 33 input unit, display unit, 40 simulator, 41 CPU, 42 memory, 50 verification device, 51 CPU, 52 memory, 53 item instruction unit, 54 response instruction unit, 55 information acquisition unit, 56 comparison unit, 57 output unit, 58 input unit, 59 display unit, 100 diagnosis device verification system

1. A diagnosis device verification system, comprising:
a diagnosis device communicably connected to a vehicle controller mounted on a vehicle, and configured to diagnose the vehicle;
a simulator configured to perform simulation operation of the vehicle controller; and
a verification device communicably connected to the diagnosis device and the simulator, and configured to verify operation of the diagnosis device, wherein
the diagnosis device is configured to output a diagnosis result acquired by communication with the simulator, wherein
the verification device includes: a CPU and a memory coupled to the CPU, wherein
the CPU is configured to function as:
an item instruction unit configured to instruct a diagnosis item to be diagnosed to the diagnosis device;
a response instruction unit configured to instruct response content corresponding to the diagnosis item instructed by the item instruction unit, to the simulator;
a result acquisition unit configured to acquire the diagnosis result output from the diagnosis device; and
a comparison unit configured to compare the diagnosis result acquired by the result acquisition unit and the response content corresponding to the diagnosis item instructed by the response instruction unit.

2. The diagnosis device verification system according to claim 1, wherein
the diagnosis device includes:
a display unit configured to display the diagnosis result acquired by the communication with the simulator, wherein
the comparison unit compares: at least one of text information and image information included in the diagnosis result displayed on the display unit; and at least one of text information and image information included in the response content corresponding to the diagnosis item instructed by the response instruction unit.

3. The diagnosis device verification system according to claim 1, further comprising:
a plurality of slave computers respectively including the verification device; and
a master computer configured to integrate the plurality of slave computers, wherein
the plurality of slave computers respectively output the verification result by performing verification of the verification item different from each other, wherein
the master computer receives the verification result output from the plurality of slave computers.

4. The diagnosis device verification system according to claim 1, wherein
the memory is configured to store: a first diagnosis item previously set corresponding to a first model to be diagnosed by the diagnosis device; and a second diagnosis item set corresponding to a second model to be diagnosed by the diagnosis device and including the first diagnosis item and an additional item added to the first diagnosis item; wherein
the verification device further includes:
an input unit configured to input the additional item, wherein
the item instruction unit instructs the first diagnosis item stored in the memory to the diagnosis device when the first model is to be diagnosed by the diagnosis device, and instructs the second diagnosis item stored in the memory to the diagnosis device when the second model is to be diagnosed by the diagnosis device.

5. A diagnosis device verification method configured to communicate with each of: a diagnosis device communicably connected to a vehicle controller mounted on a vehicle, and configured to diagnose the vehicle; and a simulator configured to perform simulation operation of the vehicle controller, and to verify operation of the diagnosis device, the diagnosis device verification method comprising:
instructing a diagnosis item to be diagnosed to the diagnosis device;
instructing response content corresponding to the diagnosis item instructed to the diagnosis device, to the simulator;
acquiring a diagnosis result acquired by the diagnosis device by communication with the simulator; and
comparing the diagnosis result acquired from the diagnosis device and the response content corresponding to the diagnosis item instructed to the diagnosis device.

6. The diagnosis device verification method according to claim 5, wherein
the comparing includes comparing: at least one of text information and image information included in the diagnosis result acquired by the diagnosis device by communication with the simulator and displayed on a display unit; and at least one of text information and image information included in the response content corresponding to the diagnosis item instructed to the simulator.

7. A diagnosis device verification system, comprising:
a diagnosis device communicably connected to a vehicle controller mounted on a vehicle, and configured to diagnose the vehicle;
a simulator configured to perform simulation operation of the vehicle controller; and
a verification device communicably connected to the diagnosis device and the simulator, and configured to verify operation of the diagnosis device, wherein
the diagnosis device is configured to output a diagnosis result acquired by communication with the simulator, wherein
the verification device includes: a CPU and a memory coupled to the CPU, wherein
the CPU is configured to perform:
instructing a diagnosis item to be diagnosed to the diagnosis device;
instructing response content corresponding to the diagnosis item instructed in the instructing, to the simulator;
acquiring the diagnosis result output from the diagnosis device; and
comparing the diagnosis result acquired in the acquiring and the response content corresponding to the diagnosis item instructed in the instructing.

8. The diagnosis device verification system according to claim 7, wherein
the diagnosis device includes:
a display unit configured to display the diagnosis result acquired by the communication with the simulator, wherein
the CPU is configured to perform:
the comparing including comparing: at least one of text information and image information included in the diagnosis result displayed on the display unit; and at least one of text information and image information included in the response content corresponding to the diagnosis item instructed in the instructing.

9. The diagnosis device verification system according to claim 7, further comprising:
a plurality of slave computers respectively including the verification device; and
a master computer configured to integrate the plurality of slave computers, wherein
the plurality of slave computers respectively output the verification result by performing verification of the verification item different from each other, wherein
the master computer receives the verification result output from the plurality of slave computers.

10. The diagnosis device verification system according to claim 7, wherein
the memory is configured to store: a first diagnosis item previously set corresponding to a first model to be diagnosed by the diagnosis device; and a second diagnosis item set corresponding to a second model to be diagnosed by the diagnosis device and including the first diagnosis item and an additional item added to the first diagnosis item; wherein
the verification device further includes:
an input unit configured to input the additional item, wherein
the CPU is configured to instruct the first diagnosis item stored in the memory to the diagnosis device when the first model is to be diagnosed by the diagnosis device, and to instruct the second diagnosis item stored in the memory to the diagnosis device when the second model is to be diagnosed by the diagnosis device.
